(19) United States
(12) Patent Application Publication
(10) Pub. No.: US 2014/0114952 A1
(43) Pub. Date: Apr. 24, 2014

(54) OPTIMIZING QUERIES OF PARALLEL DATABASES

(71) Applicant: MICROSOFT CORPORATION, Redmond, WA (US)

(72) Inventors: Eric R. Robinson, Madison, WI (US); Alan Dale Halverson, Verona, WI (US); Rimma V. Nehme, Madison, WI (US); Srinath Shankar, Madison, WI (US)

(73) Assignee: MICROSOFT CORPORATION, Redmond, WA (US)

(21) Appl. No.: 13/657,891

(22) Filed: Oct. 23, 2012

(51) Int. Cl. G06F 17/30

(52) U.S. Cl. 707/718; 707/E17.017

(57) ABSTRACT

The present invention extends to methods, systems, and computer program products for optimizing queries of parallel databases. Queries can be partially optimized at an optimizer that is unaware of its use to optimize queries for parallel processing. The optimizer can produce a data structure (e.g., a SQL Server MEMO) that encapsulates a logical serial plan search space. The logical serial plan search space may not incorporate any notion of parallelism into the plan space itself. A parallel-aware optimizer can parallelize the logical serial plan search space by augmenting the data structure (e.g., transforming the SQL Server MEMO into a parallel MEMO). Augmentation can be with data movement operations that move data associated one or more compute nodes in a distributed architecture. Cost estimates can be calculated for the operations contained in the parallelized data structure. The parallel plan with the lowest estimated cost can be selected for the query.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, database management, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some environments, queries are issued against a corpus of data to facilitate targeted information retrieval from the corpus of data. A user (or even a computer system) formulates a query using constructs from a query language. A query language typically includes a number of constructs that can be grouped into different combinations to express a logical intent for retrieving data. The query is issued to a data management system for processing. The data management system translates the query into a corresponding set of compatible physical operations (sometimes and hereinafter referred to as a “query plan”) for realizing the expressed logical intent. The query plan can then be executed to retrieve data from the corpus of data in accordance with the expressed logical intent. Retrieved data can be returned to the query issuer.

For example, SQL can be used to formulate a query for retrieving data from a relational database. The query is issued to a database management system that controls access to the relational database. The database management system translates the query into a query plan. The query plan is then executed to retrieve data from the relational database. The retrieved database data can be returned to the query issuer.

Using constructs of a query language, there can be any number of different ways to express the same logical intent for retrieving data. When translating a query, there can also be any number of ways to combine physical operations into a query plan for realizing an expressed logical intent. Thus, generally, different sets of physical operations can be executed to realize a logical intent that can also be expressed in different ways.

However, different query plans (i.e., different arrangements of physical operations), all of which correctly realize the same logical intent, can have different performance based on system hardware and configuration, data layout, etc. For example, one query plan for a query might execute in 5 seconds, while another query plan for the same query might execute in 15 seconds.

As such, many data management systems use a query optimizer. A query optimizer evaluates various different possible query plans for a query. The query optimizer attempts to select a better performing query plan for a query (e.g., relative to other query plans for obtaining the same result) based on a query's expressed logical intent and data layout.

Some database systems are standalone (or single node) database systems where all data and optimization data is physically stored at the same machine. For a standalone database system, physical operations in a query plan are typically executed using serial, sequential processing. Query optimization is also relatively straightforward. Since all information for optimization is available in a single location, a query optimizer can relatively easily refer to the information and select higher performing query plans.

Other database systems are parallel database systems. In a parallel database system, database storage is spread across a number of nodes. Each node stores one or more portions of a database locally. Other modules (e.g., at a control node) abstract the distributed nature of the database from users such that it appears as a single unified database. As such, in a parallel database system, data relevant to a query as well as data used for query plan optimization can be spread out across a number of different nodes.

Parallel databases improve performance for tasks such as loading data and building indices. Parallel databases improve processing and input/output speeds by using multiple central processing units (CPUs) (including multi-core processors) and storage in parallel. In parallel processing, many operations are performed simultaneously, as opposed to serial, sequential processing, where operations are performed with no time overlap. Parallel databases can be implemented in different architectures including: a shared memory architecture (multiple processors share memory space and other data storage), a shared disk architecture (each processing unit has its own memory but shares other data storage), and a shared-nothing architecture (each processing unit has its own memory space and its own other data storage).

In a parallel database environment, query plan optimization can be somewhat more complicated as data relevant to a query as well as data used for query plan optimization are distributed across a number of nodes (which, for example, in a shared-nothing architecture may not even be aware of each other's existence). Further, query plans for parallel database systems can include additional operations, not used when querying standalone database systems, which also have to be optimized. As such, mechanisms used to optimize queries for standalone databases are typically insufficient for optimizing queries used in parallel database environments.

Accordingly, some other mechanisms have been developed to attempt to optimize queries for use in parallel database environments. At least one mechanism uses a heuristic, rule-based approach to query plan selection. However, the approach has at least two disadvantages. First, the approach is non-algebraic. As such, the approach may produce different plans for semantically identical queries. Second, the approach does not consider estimated execution costs. Thus, the query plans the approach generates are completely determined by the query and the underlying database schema. As a result, the optimizer is unable to adapt its plan selection decisions as the characteristics of the underlying data change.

One other approach is to formulate the best serial query plan for a query and then parallelize the best serial query plan. However, a relatively significant disadvantage of this approach is that the best parallel plan that the optimizer could identify is often not a simple parallelization of the best serial plan that that same optimizer identifies.

### BRIEF SUMMARY

The present invention extends to methods, systems, and computer program products for optimizing queries of parallel databases. A plurality of compute nodes are configured in a shared-nothing architecture. A database is distributed across the plurality nodes such that each node locally maintains one or more portions of the database in a local database instance.

A query of the database is accessed. The query expresses a logical intent to retrieve specified data from within the database. The query is sent to an optimizer that is not aware it is being used to optimize a query for parallel processing. A data structure is received back from the optimizer. The data structure encapsulates a serial query plan search space. The serial query plan search space includes one more serial query plans for implementing the expressed logical intent of the query.

The serial query plan search space is parallelized into a parallel query plan search space. The parallel query plan search space includes one or more parallel query plans for implementing the expressed logical intent of the query. Parallelization of the serial query plan search space includes augmenting the data structure to account for data-parallelism in the database and generating cost estimates for operations contained in the augmented data structure. A parallel query plan having the lowest cost based on the generated cost estimates is identified from within the parallel query plan search space. The identified parallel query plan is selected for implementing the query.

In some embodiments, a returned data structure is an SQL Server MEMO. The SQL Server MEMO encapsulates one or more serial query plans for implementing an expressed logical intent of a query. The expressed logical intent is for retrieving specified data from within a database. The SQL Server MEMO can be accessed and transformed into a parallel MEMO.

Transforming the SQL Server MEMO includes augmenting the one or more serial query plans into one or more parallel query plans that, when executed, implement the expressed logical intent of the query and that account for data-parallelism in the database. Augmenting the one or more serial query plans includes adding at least one data movement operation to each of the one or more serial query plans. Added data movement operations are configured to move database data associated with at least one compute node.

An estimated execution cost is generated for each of the one or more parallel query plans. The estimated execution cost is based on the type of data movement operation added to the query plan and on statistics for the associated database data. The parallel query plan with the lowest estimated cost is identified and selected to implement the expressed logical intent of the query.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates optimizing queries of parallel databases.

FIG. 2 illustrates a flow chart of an example method for optimizing queries of parallel databases

FIG. 3 illustrates an example computer architecture that facilitates optimizing queries of parallel databases.

FIG. 4 illustrates a flow chart of an example method for optimizing queries of parallel databases.

FIG. 5 illustrates a data flow of an example for optimizing queries of parallel databases.

### DETAILED DESCRIPTION

The present invention extends to methods, systems, and computer program products for optimizing queries of parallel databases. A plurality of compute nodes are configured in a shared-nothing architecture. A database is distributed across the plurality nodes such that each node locally maintains one or more portions of the database in a local database instance.

A query of the database is accessed. The query expresses a logical intent to retrieve specified data from within the database. The query is sent to an optimizer that is not aware it is being used to optimize a query for parallel processing. A data structure is received back from the optimizer. The data structure encapsulates a serial query plan search space. The serial query plan search space includes one more serial query plans for implementing the expressed logical intent of the query.

The serial query plan search space is parallelized into a parallel query plan search space. The parallel query plan search space includes one or more parallel query plans for implementing the expressed logical intent of the query. Parallelization of the serial query plan search space includes augmenting the data structure to account for data-parallelism in the database and generating cost estimates for operations contained in the augmented data structure. A parallel query plan having the lowest cost based on the generated cost estimates is identified from within the parallel query plan search space. The identified parallel query plan is selected for implementing the query.

In some embodiments, a returned data structure is an SQL Server MEMO. The SQL Server MEMO encapsulates one or more serial query plans for implementing an expressed logical intent of a query. The expressed logical intent is for retrieving specified data from within a database. The SQL Server MEMO can be accessed and transformed into a parallel MEMO.

Transforming the SQL Server MEMO includes augmenting the one or more serial query plans into one or more parallel query plans that, when executed, implement the expressed logical intent of the query and that account for data-parallelism in the database. Augmenting the one or more serial query plans includes adding at least one data movement operation to each of the one or more serial query plans. Added data movement operations are configured to move database data associated with at least one compute node.

An estimated execution cost is generated for each of the one or more parallel query plans. The estimated execution cost is based on the type of data movement operation added to the query plan and on statistics for the associated database data. The parallel query plan with the lowest estimated cost is identified and selected to implement the expressed logical intent of the query.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

In this description and in the following claims, a “MEMO” is defined as a generic structure for organizing a search space. The internal structure of MEMO can viewed as collection of sub-goals that are themselves a collection of last steps that depend on other sub-goals. Within a MEMO, the solution to reaching a goal can address managing different possibilities for what the last step in the sequence (i.e., the last action required to achieve the goal) might be and to treat the task of managing different ways of getting to those possible last steps as a sub-goal to be solved later.

For the arithmetic problem “1+2+3”, for example, the last step might be adding 1 to a sub-goal (the sum of 2 and 3), or it might be adding 2 to a sub-goal (the sum of 1 and 3), or it might be adding 3 to a sub-goal (the sum of 1 and 2). If combinations for accomplishing the sub-goals for each of these possible last steps were reproducible, then it would be possible to reproduce the possible combinations of accomplishing the original goal by just tacking the appropriate last step on to the end of each possible way that its sub-goal(s) could be accomplished. This strategy can be applied recursively to each of the identified sub-goals. Eventually, an entire search space flattens out into a collection sub-goals to solve (the original goal is just a special sub-goal). Each of these sub-goals itself contains a collection of all of the possible “last steps” (tagged with the sub-goals they depend on) that could be performed to accomplish that particular sub-goal.

Embodiments of the invention include optimizing query execution for queries issued against parallel databases. Queries can be partially optimized at an optimizer that is unaware it is being used to optimize queries for parallel processing. The optimizer can produce a data structure that encapsulates a potentially non-trivial (i.e., not just the best serial plan) logical serial plan search space. The logical serial plan search space may lack any notion of parallelism.

A parallel-aware optimizer can parallelize the logical serial plan search space by augmenting the data structure. It may be that the data structure is augmented with data movement operations that move data associated one or more compute nodes in a distributed architecture. Cost estimates are calculated for the operations contained in the parallelized data structure. The plan with the lowest estimated cost is used as the plan for the query.

In some embodiments, a query is sent to a shell database for partial optimization. The shell database can perform many of the functions associated with query processing. The shell database can export a serial SQL Server MEMO for consumption by a parallel-aware optimizer. The parallel-aware optimizer can transform the serial SQL Server MEMO into a parallel MEMO. The transformation can include adding data movement operations to the serial SQL Server MEMO. The data movement operations are configured to move database data associated with at least one compute node in a distributed architecture. Generated cost estimates can be used to select a parallel query plan to implement the query.

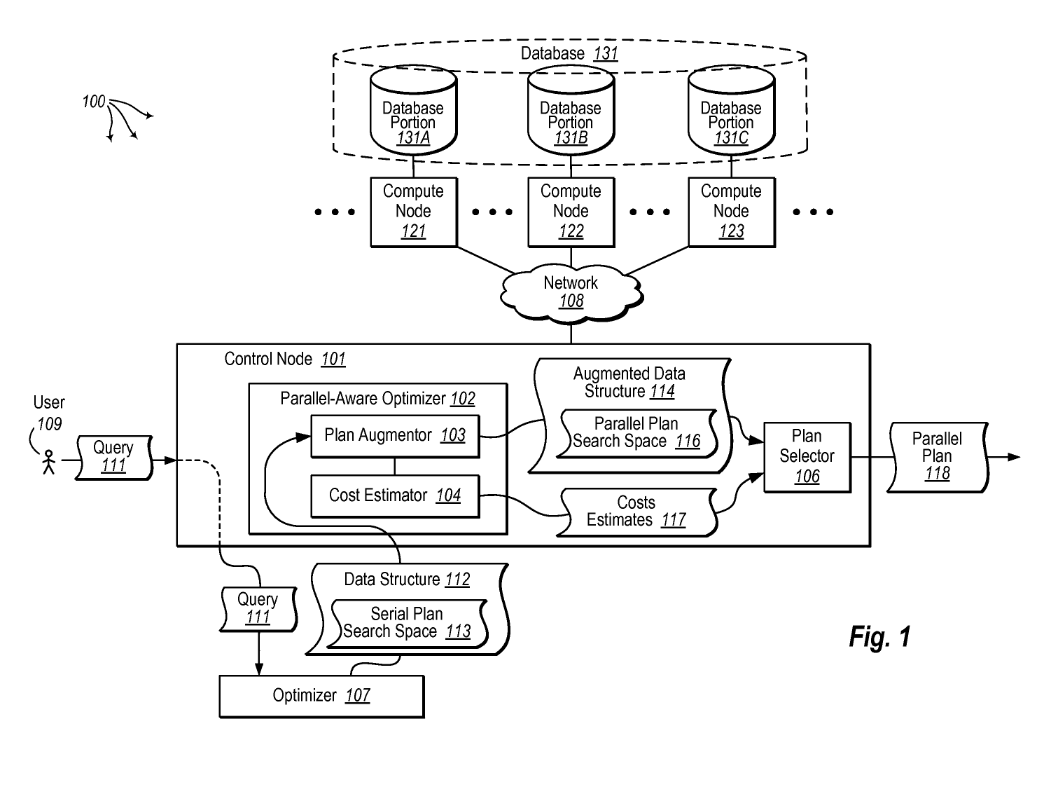

FIG. 1 illustrates an example computer architecture 100 that facilitates optimizing queries to parallel databases. Referring to FIG. 1, computer architecture 100 includes control node 101, optimizer 107, and compute node 121, 122, and 123. Control node 101, optimizer 107, and compute node 121, 122, and 123 can be connected to one another over (or be part of) network 108, such as, for example, a Local Area Network (“LAN”), a Wide Area Network (“WAN”), and even the Internet. Accordingly, control node 101, optimizer 107, and compute node 121, 122, and 123 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over network 108.

Control node 101 and compute nodes 121, 122, and 123 are configured in a shared-nothing architecture. As such, control node 101 and each of compute nodes 121, 122, and 123 maintain separate memory (e.g., RAM) and separate storage resources (e.g., disk drives) from other nodes. Database 131 is distributed across computer node 121, 122, and 123, which maintain database portions 131A, 131B, and 131C respectively. Control node 101 includes abstraction hardware and/or software components that abstract the distributed nature of database 131. Control node 101 can use the abstraction hardware and/or software components to present database 131 as a standalone database to user 109. Thus, user 109 can interact with database 131 using commands compatible with a standalone database (including submitting queries).

The ellipses before, between, and after compute nodes 121, 122, and 123 represent that other compute nodes can be included in the shared-nothing architecture. These other compute nodes may store portions of other databases. In addition to storing a portion of database 131, compute nodes 121, 122, and 123 may also store portions of these other databases.

Users or other computer systems can request retrieval of data from database 131 by submitting queries. Queries of database 131 can be received at control node 101. Queries can be submitted in a programming language, such as, for example, SQL, and can express a logical intent for retrieving specified data from database 131.

For any query, there can be a plurality of different sets of physical operations that can be executed to implement the expressed logical intent. In general, control node 101 can select a parallel query plan that is at least better than many other parallel query plans for implementing an expressed logical intent of a query. Control node 101 can balance the amount of time spent selecting a parallel query plan against the amount time for running a parallel query plan. Control node 101 can used cost based optimizing to evaluate a resource footprint of various parallel query plans and use this as the basis for parallel query plan selection. Costed resources can be based on input cardinality and can include CPU path length, amount of disk buffer space, disk storage service time, interconnect usage between units of parallelism, etc.

As depicted, control node 101 includes parallel-aware optimizer 102 and plan selector 106. Parallel-optimizer 102 further includes plan augmentor 103 and cost estimator 104. Parallel-aware optimizer 102 can receive a serial query plan search space. Parallel-aware optimizer 102 can parallelize the serial query plan search space and generate (e.g., resource usage) cost estimates for operations included in the serial plan search space. For example, plan augmentor 103 can generate parallel query plans for inclusion in a parallel query plan search space by augmenting serial query plans in a serial query plan search space with additional operations (e.g., data movement operations). Cost estimator 104 can generate cost estimates for operations, including operations added through augmentation, within a parallel query plan search space.

Plan selector 106 can receive a parallel query plan search space and cost estimates. Plan selection 106 can use the cost estimates to identify a parallel query plan, within the parallel query plan search space, having the lowest (e.g., resource usage) cost. Plan selector 106 can select the identified parallel query plan for implementing the expressed logical intent of a query.

Optimizer 107 can be an (e.g., existing) optimizer configured to optimize queries for execution in a standalone environment. Optimizer 107 may be unaware of nodes arranged in a shared-nothing architecture or that a query is being optimized for execution in a parallel database environment. Nonetheless, portions of the functionality of optimizer 107 can be (re)used for optimizing queries for execution in computer architecture 100. For example, optimizer 107 can be used to initially populate a data structure with serial query plans for implementing an expressed logical intent of a query. Optimizer 107 can also be used to expand a search space of serial query plans within a data structure.

Thus, upon receiving a query, control node 101 can forward the query to optimizer 107. Optimizer 107 can return a data structure including a serial query plan search space for the query back to control node 101. The serial query plan search space can include a plurality of serial query plans for implementing the expressed logical intent of the query. Control node 101 can receive the data structure from optimizer 107 and pass the data structure to parallel-aware optimizer 102 for parallelization.

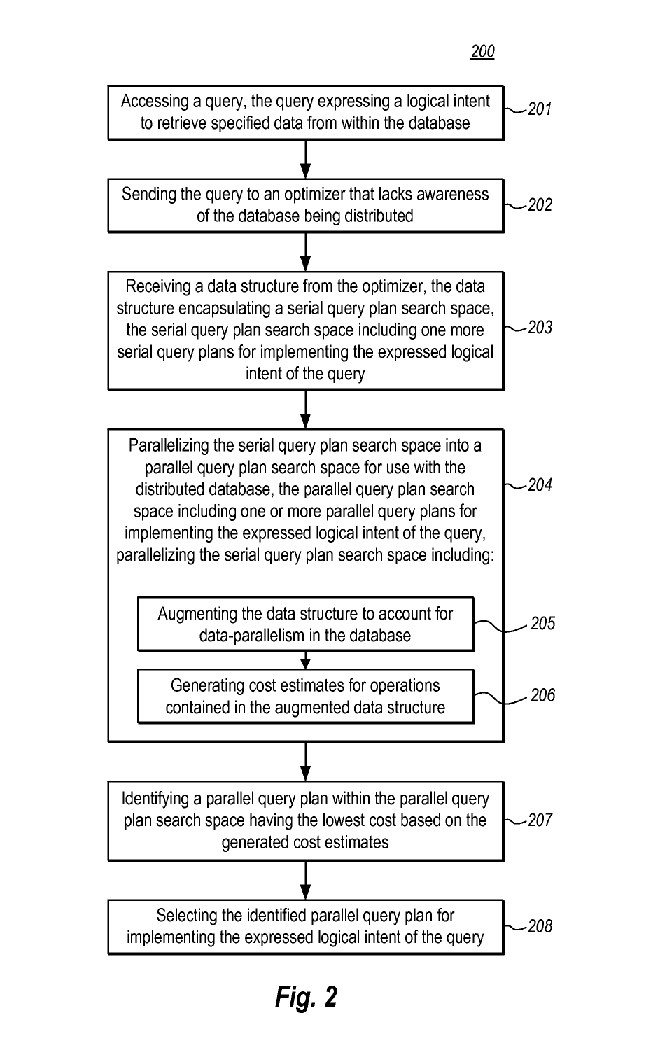

FIG. 2 illustrates a flow chart of an example method 200 for optimizing queries of parallel databases. Method 200 will be described with respect to the components and data of computer architecture 100.

Method 200 includes accessing the query, the query expressing a logical intent to retrieve specified data from within the database (201). For example, user 109 can issue query1 (e.g., a SQL query). Query 111 can express a logical intent for retrieving specified data from database 331. Control node 101 can access query 111. Alternately, query 111 can be issued from some other user or query 111 can be issued from a computer system.

Method 200 includes sending the query to an optimizer that lacks awareness of the database being distributed (202). For example, control node 101 can send query 111 to optimizer 107.

Optimizer 107 can receive query 111 from control node 101. From query 111, optimizer 107 can generate data structure 112 containing serial plan search space 113. Search plan search space 113 can include one or more serial query plans for implementing the expressed logical intent of query 111. Optimizer 107 can send data structure 112 to control node 101.

Method 200 includes receiving a data structure from the optimizer, the data structure encapsulating a serial query plan search space, the serial query plan search space including one more serial query plans for implementing the expressed logical intent of the query (203). For example, control node 101 can receive data structure 112, containing serial plan search space 113, from optimizer 107. As described, serial plan search space 113 can include one or more of serial query plans for implementing the expressed logical intent of query 111.

Method 200 includes parallelizing the serial query plan search space into a parallel query plan search space for use with the distributed database, the parallel query plan search space including one or more parallel query plans for implementing the expressed logical intent of the query (204). For example, parallel-aware optimizer 102 can parallelize serial plan search space 113 into parallel plan search space 116 for use with database 131. Parallel plan search space 116 can include one or more parallel query plans for implementing the expressed logical intent of query 111.

Parallelizing the serial query plan search space includes augmenting the data structure to account for data-parallelism in the database (205). For example, plan augmentor 103 can augment data structure 112 into augmented data structure 114. Augmented data structure 114 can account for data-parallelism in database 131. In some embodiments, augmenting a data structure to account for parallelism includes adding data movement operations (e.g., replicate, shuffle, broadcast, partition move, master moves, etc.) to serial query plans within the data structure.

Parallelizing the serial query plan search space includes generating cost estimates for operations contained in the augmented data structure (206). For example, cost estimator 104 can generate cost estimates 117 for operations contained in augmented data structure 114. A cost estimates can be generated for operations entered into serial plan search space 113 at optimizer 107 and/or entered (augmented) into a parallel plan search space 116 at parallel-aware optimizer 102. For each operation, a cost estimate can be can be based on input cardinality and can include CPU path length, amount of disk buffer space, disk storage service time, interconnect usage between units of parallelism, etc.

Method 200 includes identifying a parallel query plan within the parallel query plan search space having the lowest cost based on the generated cost estimates (207). For example, plan selector 106 can identified parallel plan 118, from within parallel plan space 116, as having the lowest cost based on cost estimates 117. Method 200 includes selecting the identified parallel query plan for implementing the expressed logical intent of the query (208). For example, plan selector 106 can select parallel plan 118 for implementing the expressed logical intent of query 111 (i.e., to retrieve specified data from database 131).

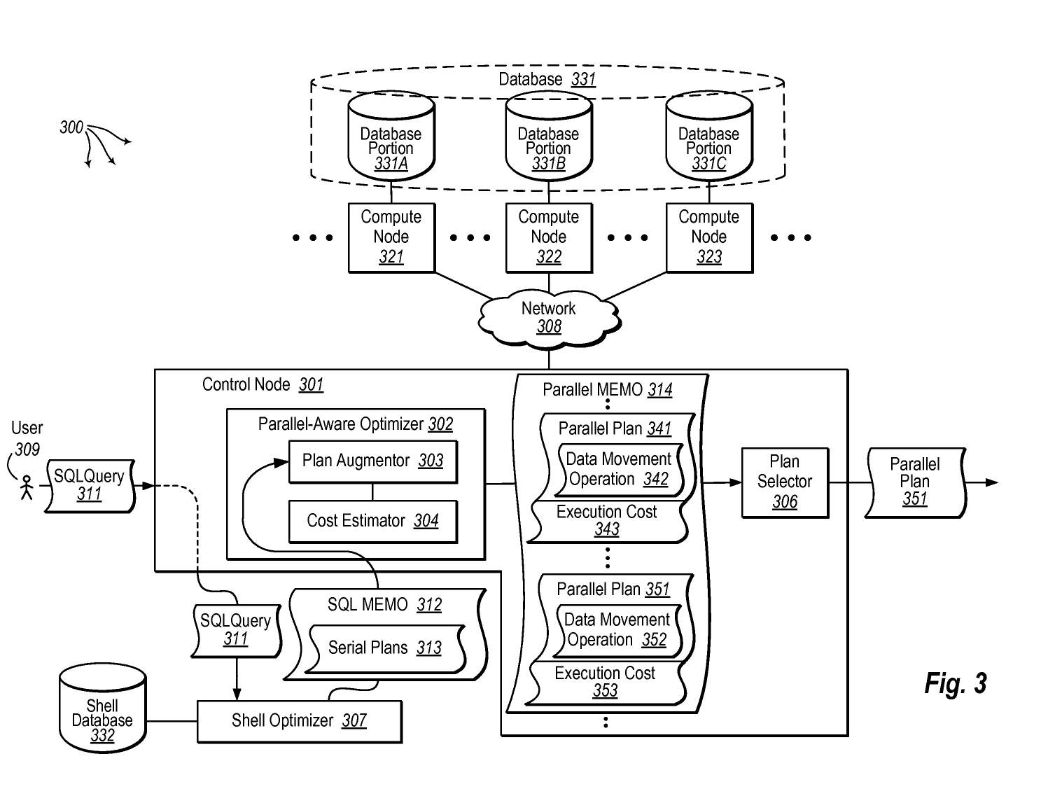

FIG. 3 illustrates an example computer architecture 300 that facilitates optimizing queries to parallel databases. Referring to FIG. 3, computer architecture 300 includes control node 301, optimizer 307, compute node 321, 322, and 323, and shell database 332. Control node 301, optimizer 307, compute node 321, 322, and 323, and shell database 332 can be connected to one another over (or be part of) network 308, such as, for example, a Local Area Network (“LAN”), a Wide Area Network (“WAN”), and even the Internet. Accordingly, control node 301, optimizer 307, compute node 321, 322, and 323, and shell database 332 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over network 308.

Control node 301 and compute nodes 321, 322, and 323 are configured in a shared-nothing architecture. As such, control node 301 and each of compute nodes 321, 322, and 323 maintain separate memory (e.g., RAM) and separate storage resources (e.g., disk drives) from other nodes. Database 331 is distributed across computer node 321, 322, and 323, which maintain database portions 331A, 331B, and 331C respectively. Control node 301 includes abstraction hardware and/or software components that abstract the distributed nature of database 331. Control node 301 can use the abstraction hardware and/or software components to present database 331 as a standalone database to user 309. Thus, user 309 can interact with database 331 using commands compatible with a standalone database (including submitting queries).

The ellipses before, between, and after compute nodes 321, 322, and 323 represent that other compute nodes can be included in the shared-nothing architecture. These other compute nodes may store portions of other databases. In addition to storing a portion of database 331, compute nodes 321, 322, and 323 may also store portions of these other databases.

Users or other computer systems can request retrieval of data from database 331 by submitting queries. Queries of database 331 can be received at control node 301. Queries can be submitted in a programming language, such as, for example, SQL and can express a logical intent for retrieving specified data from database 331.

In general, control node 301 can select a parallel query plan that is at least better than many other parallel query plans for implementing an expressed logical intent of a query. Control node 301 can balance the amount of time spent selecting a parallel query plan against the amount time for running a parallel query plan. Control node 301 can used cost based optimizing to evaluate a resource footprint of various parallel query plans and use this as the basis for parallel query plan selection. Costed resources can be based on input cardinality and can include CPU path length, amount of disk buffer space, disk storage service time, interconnect usage between units of parallelism, etc.

As depicted, control node 301 includes parallel-aware optimizer 302 and plan selector 306. Parallel-optimizer 302 further includes plan augmentor 303 and cost estimator 304. Parallel-aware optimizer 302 can receive a SQL Server MEMO containing serial query plans. Parallel-aware optimizer 302 can parallelize the serial query plans and generate (e.g., resource usage) cost estimates for operations included in the serial query plans. For example, plan augmentor 303 can generate parallel query plans for inclusion in a parallel MEMO by augmenting serial query plans in a SQL Server MEMO with additional operations (e.g., data movement operations). Cost estimator 304 can generate cost estimates for operations, including operations added through augmentation, within a parallel MEMO.

Plan selector 306 can receive a parallel MEMO and cost estimates. Plan selection 106 can use the cost estimates to identify a parallel query plan, within the parallel MEMO, having the lowest (e.g., resource usage) cost. Plan selector 306 can select the identified parallel query plan for implementing the expressed logical intent of a query.

Shell optimizer 307 can be an (e.g., existing) optimizer configured to optimize queries for execution in a standalone environment. Shell optimizer 307 may be unaware of nodes arranged in a shared-nothing architecture or that a query is being optimized for execution in a parallel database environment. Nonetheless, portions of the functionality of shell optimizer 307 can be (re)used for optimizing queries for execution in computer architecture 300. For example, optimizer 307 can be used to initially populate a SQL Server MEMO with serial query plans for implementing an expressed logical intent of a query. Optimizer 307 can also be used to expand a search space of serial query plans within a SQL Server MEMO. Shell optimizer 307 can refer to statistics stored in shell database 332 during optimization.

Thus, upon receiving a query, control node 301 can forward the query to shell optimizer 307. Shell optimizer 307 can return a SQL Server MEMO back to control node 301. The SQL Server MEMO can include a plurality of serial query plans for implementing the expressed logical intent of the query. Control node 301 can receive the SQL Server MEMO from shell optimizer 307 and pass the SQL Server MEMO to parallel-aware optimizer 102 for parallelization.

In general, a goal of shell optimizer 307 is to generate the entire set of all possible serial query plans for the query. If a query is simple enough, shell optimizer 307 may be able to generate the entire space of plans in a reasonable period of time. On the other hand, for more complex queries, a full plan space may be so large that it is impractical to generate all possible serial query plans. Shell optimizer 307 can account for increased complexity by generating candidate execution plans in multiple stages that vary in their restrictions on which transformation rules can be applied. Earlier stages have more restrictions on the set of permissible rules and, consequently, generate smaller plan spaces. A final stage has no restrictions on the set of permissible rules and, hence, attempts to generate the entire plan space.

To ensure timely optimization, shell optimizer 307 can enforce time limits on each stage. If a stage completes before its time limit is reached then optimization is allowed to proceed to the next stage. If a stage times out before running to completion then optimization stops and the optimizer returns the best plan that it has found so far. One way shell optimizer 307 accounts for more complex queries that may time out is by “MEMO seeding.” MEMO seeding can be used to guide the plan space exploration towards areas of the search space that are heuristically determined to be promising. Guiding plan exploration can include initially populating the MEMO with a tree that is (e.g., again, heuristically) deemed to be “close to” the desired search space. In practice, MEMO seeding can include choosing a promising initial join order.

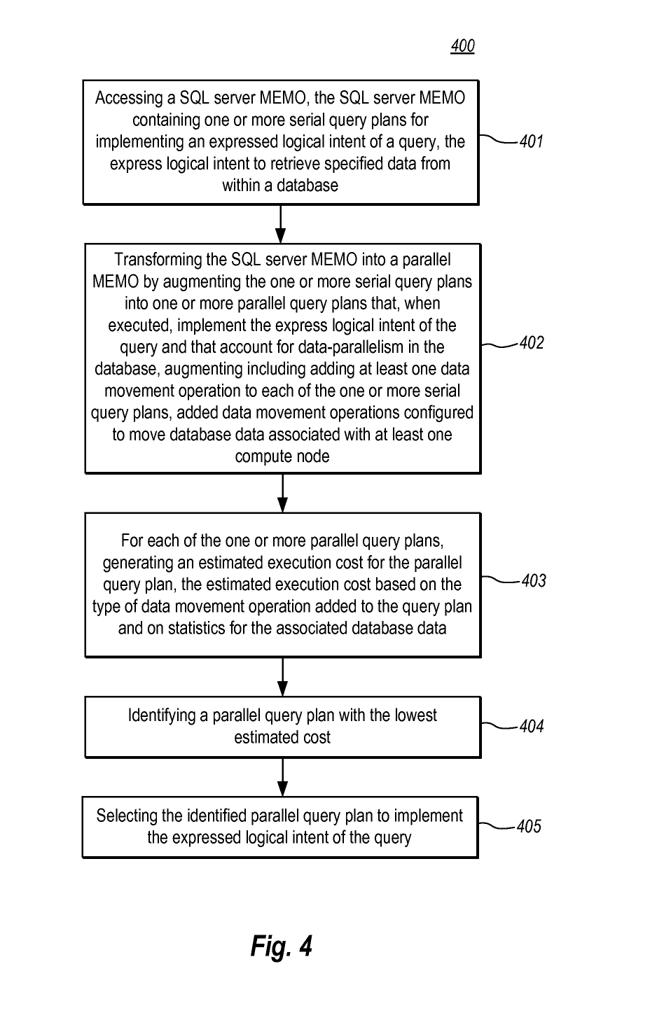

FIG. 4 illustrates a flow chart of an example method 400 for optimizing queries of parallel databases. Method 400 will be described with respect to the components and data of computer architecture 300.

User 309 can issue SQL query 311. SQL query 311 can express a logical intent for retrieving specified data from database 331. Control node 301 can access SQL query 311. Alternately, SQL query 311 can be issued from some other user or query 311 can be issued from a computer system. Control node 301 can send SQL query 311 to shell optimizer 307

Shell optimizer 307 can receive SQL query 311 from control node 301. From query 311, optimizer 307 can generate SQL MEMO 312 containing serial plans 313. Serial plans 313 can include one or more serial query plans for implementing the expressed logical intent of query 311. Shell optimizer 307 can refer to statistics in shell database 332 during identification of serial plans for inclusion in SQL MEMO 312. Shell optimizer 307 can send SQL MEMO 312 to control node 301.

Method 400 includes accessing a SQL Server MEMO, the SQL Server MEMO containing one or more serial query plans for implementing an expressed logical intent of a query, the express logical intent to retrieve specified data from within the database (act 401). For example, control node 301 can receive SQL MEMO 312 from shell optimizer 307. As described, SQL MEMO 312 contains serial plans 312. Serial plans 312 includes one or more serial query plans for implementing the expressed logical intent of SQL query 311.

Method 400 includes transforming the SQL Server MEMO into a parallel MEMO by augmenting the one or more serial query plans into one or more parallel query plans that, when executed, implement the express logical intent of the query and that account for data-parallelism in the database, augmenting including adding at least one data movement operation to each of the one or more serial query plans, added data movement operations configured to move database data associated with at least one compute node (act 402). For example, parallel-aware optimizer 302 can transform SQL MEMO 312 into parallel MEMO 314. Plan augmentor 303 can augment serial plans 313 into corresponding parallel plans including parallel plan 341, parallel plan 351, etc. that, when executed, implement the expressed logical intent of SQL query 311. Each of parallel plans 341, 351, etc. account for data-parallelism in database 331.

Augmenting an SQL Server MEMO can include adding data movement operations to each of serial plans 313. For example, plan augementor 303 can add data movement operations 342 and 352 to parallel plans 341 and 351 respectively. Each of data movement operations 342 and 352 (e.g., replicate, shuffle, broadcast, partition move, master move, etc.) can move database data associated with (e.g., to, from, or between) one or compute nodes 321, 322, and 323.

Method 400 includes for each of the one or more parallel query plans, generating an estimated execution cost for the parallel query plan, the estimated execution cost based on the type of data movement operation added to the query plan and on statistics for the associated database data (act 403). For example, for each parallel plans 341, 351, etc., cost estimator 304 can generate execution cost 343, 353, etc. Execution cost 343 can be based on the operation type of data movement operation 342 and on statistics (e.g., input cardinality) for database data in database 331. Execution cost 353 can be based on the operation type of data movement operation 352 and on statistics (e.g., input cardinality) for database data in database 331.

Method 400 includes identifying a parallel query plan with the lowest estimated cost (act 404). For example, execution cost 353 can be the lowest execution cost in parallel MEMO 314. Thus, plan selector 306 can identify parallel plan 351.

Method 400 includes selecting the identified parallel query plan to implement the expressed logical intent of the query (act 405). For example, plan selector 306 can select parallel plan 351 to implement the expressed logical intent of query 311 (i.e., to retrieve specified data from database 331).

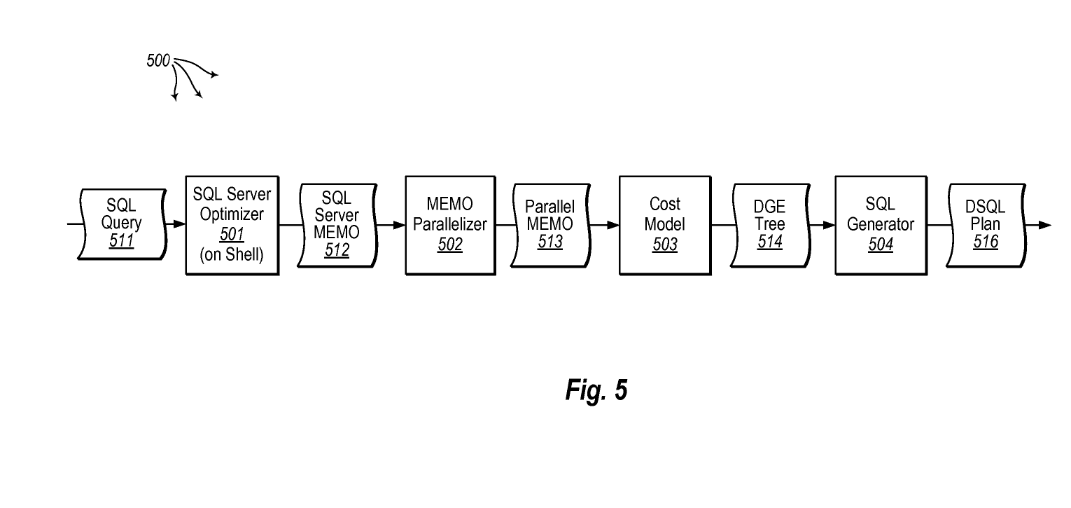

FIG. 5 illustrates a data flow 500 of an example for optimizing queries of parallel databases. As depicted, a string representation of an original user query can be sent to SQL server optimizer 501 (a shell instance of SQL server) under showplan. The SQL server optimizer 501 produces SQL Server MEMO 512 for SQL query 511. SQL server optimizer 501 can produce SQL Server MEMO 512 based on a global view of statistics of the data in a distributed database. SQL server optimizer 501 passes the SQL Server MEMO 512 to MEMO parallelizer 502.

MEMO parallelizer 502 transforms SQL Server MEMO 512 into parallel MEMO 513. Parallel MEMO 513 contains a search space of DSQL query plans. Parallel MEMO 513 can include additional groups of expressions to manage plan steps that reference temp tables. Parallel MEMO 513 can also include, in addition to Logical Group Expressions (“LGEs”) and Physical Group Expressions (“PGEs”), a list of DSQL Group Expressions (“DGEs”)

Cost model 503 generates cost estimates for candidate DSQL query plans in parallel MEMO 513. Cost model 503 can estimate costs for data movement operations based on the type of operation (e.g., replicate, shuffle, broadcast, partition move, master move, etc.) and the projected statistics of the tuples to be redistributed. Cost model 503 can also estimate T-SQL statement execution costs base on node-local statistics over data in the distributed database. Node-local statistics can be used because of closer correspondence to the statistics that the SQL server instances on the nodes use to generate execution plans.

After generating cost estimates for candidate plans, cost model 503 identifies the DSQL query plan with the lowest estimated execution cost. Cost model 503 extracts the identified plan as DGE tree 514. Cost model 503 passes DGE tree 514 to SQL generator 504. SQL generator 504 converts DGE tree 514 into DSQL plan 516. Converting a DGE tree into a DSQL plan can include, for each DGE in the DGE tree, generating a T-SQL statement that is semantically equal to the LogOp/PhyOP search space pointed to by the DGE.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including one or more processors and system memory, the computer system connected to a plurality of compute nodes configured in a shared-nothing architecture, a database distributed across the plurality of compute nodes, each compute node in the plurality of compute nodes maintaining a portion of the database in a local database instance, a method for optimizing a query of the database, the method comprising:
accessing the query, the query expressing a logical intent to retrieve specified data from within the database;
sending the query to an optimizer that lacks awareness of the database being distributed;
receiving a data structure from the optimizer, the data structure encapsulating a serial query plan search space, the serial query plan search space including one more query plans for implementing the expressed logical intent of the query;
parallelizing the serial query plan search space into a parallel query plan search space for use with the distributed database, the parallel query plan search space including one or more parallel query plans for implementing the expressed logical intent of the query, parallelizing the serial query plan search space including:
augmenting the data structure to account for data-parallelism in the database;
generating cost estimates for operations contained in the augmented data structure;
identifying a parallel query plan within the parallel query plan search space having the lowest cost based on the generated cost estimates; and
selecting the identified parallel query plan for implementing the expressed logical intent of the query.

2. The method of claim 1, wherein sending the query to an optimizer that lacks awareness of the database being distributed comprises sending the query to a shell database optimizer.

3. The method of claim 2, wherein receiving a data structure from the optimizer comprises receiving a MEMO data structure from the shell database optimizer.

4. The method of claim 3, wherein receiving a MEMO data structure from the shell database comprises receiving a MEMO data structure containing the serial query plan search space, the serial query plan search space having been optimized based on schema and statistics for the database.

5. The method of claim 1, wherein receiving a data structure from the optimizer comprises receiving a MEMO data structure including one or more serial query plans that were used to seed the MEMO data structure based on extended properties of the database.

6. The method as recited in claim 1, wherein augmenting the data structure to account for data-parallelism in the database comprises augmenting an SQL Server MEMO to account for data-parallelism in the database.

7. The method as recited in claim 6, wherein augmenting a SQL Server MEMO to account for data-parallelism in the database comprises adding data movement operations to the SQL Server MEMO.

8. The method as recited in claim 7, wherein generating cost estimates for operations contained in augmented data structure comprises generating cost estimates for the data movement operations added to the SQL Server MEMO data structure.

9. The method as recited in claim 7, wherein generating cost estimates for operations contained in augmented data structure comprises generating cost estimates for one or more non-data movement operations in the SQL Server MEMO data structure.

10. The method as recited in claim 1, wherein generating cost estimates for operations contained in augmented data structure comprises generating cost estimates for one or more of: a replicate operation, a shuffle operation, a broadcast operation, a partition move operation, and a master move operation.

11. At a computer system, the computer system including one or more processors and system memory, the computer system also including a parallel-aware query optimizer, the computer system connected to a plurality of compute nodes configured in a shared-nothing architecture, a database distributed across the plurality of compute nodes, each compute node in the plurality of compute nodes maintaining a portion of a database in a local database instance, a method for optimizing a query of the database, the method comprising:
accessing a SQL Server MEMO, the SQL Server MEMO encapsulating one or more serial query plans for implementing an express logical intent of the query, the express logical intent to retrieve specified data from within the database;
transforming the SQL Server MEMO into a parallel MEMO by augmenting the one or more serial query plans into one or more parallel query plans that, when executed, implement the express logical intent of the query and that account for data-parallelism in the database, augmenting including adding at least one data movement operation to each of the one or more serial query plans, added data movement operations configured to move database data associated with at least one compute node;
for each of the one or more parallel query plans, generating an estimated execution cost for the parallel query plan, the estimated execution cost based on the type of data movement operation added to the query plan and on statistics for the associated database data;
identifying a parallel query plan with the lowest estimated cost; and
selecting the identified parallel query plan to implement the expressed logical intent of the query.

12. The method claim 11, wherein accessing a SQL Server MEMO comprises accessing an SQL Server MEMO that includes at least one query plan used to seed generation of the SQL Server MEMO.

13. The method claim 11, wherein transforming the SQL Server MEMO into a parallel MEMO comprises adding a DSQL group expression to the SQL Server MEMO.

14. The method of claim 11, wherein using the identified augmented query plan for the query comprises:
extracting the identified augmented query plan from the parallel MEMO as a DSQL group expression tree;
sending the DSQL group expression tree to an SQL generator to generate a DSQL plan for execution.

15. The method of claim 11, wherein generating an estimated execution cost for the augmented query plan comprises generating an estimated execution cost for the augmented query plan based on one or more non-data movement operators.

16. The method of claim 11, wherein generating an estimated execution cost for the parallel query plan comprises generating an estimated execution cost for one or more of: a replicate operation, a shuffle operation, a broadcast operation, a partition move operation, and a master move operation.

17. A distributed database system, the distributed database system comprising:
a distributed database, the distributed database distributed across a plurality of compute nodes;
the plurality of compute nodes configured and a control node configured in a shared-nothing architecture, each compute node including:
one or more processors;
system memory; and
one or more storage devices; and
each compute node maintaining a portion of the database in a local database instance at the one or more storage devices;
the control node including:
one or more processors;
system memory;
one or more computer storage devices having stored thereon computer executable instructions representing a parallel-aware optimizer and a plan selector, the control node configured to:
access a query, the query expressing a logical intent to retrieve specified data from within the database; and
send the query to a SQL server optimizer; and
wherein the parallel-aware optimizer is configured to:
receive a data structure from the SQL server optimizer, the data structure containing a serial query plan search space, the serial query plan search space including one more query plans for implementing the expressed logical intent of the query; and
parallelize the serial query plan search space into a parallel query plan search space for use with the distributed database, the parallel query plan search space including one or more parallel query plans for implementing the expressed logical intent of the query, parallelizing the serial query plan search space including:
augment the data structure to account for data-parallelism in the database;
generate cost estimates for operations contained in the augmented data structure;
wherein the plan selector is configured to:
identify a parallel query plan within the parallel query plan search space having the lowest cost based on the generated cost estimates; and
select the identified parallel query plan for implementing the expressed logical intent of the query; and
the SQL server optimizer including:
a shell database;
the SQL server optimizer configured to:
receive the query from the control node;
generate the data structure containing the serial query plan search space for the query by referring to statistics in the shell database; and
return the data structure containing the serial query plan search space to the control node.

18. The system as recited in claim 17, wherein the SQL server optimizer being configured to generate the data structure containing the serial query plan search space comprises the SQL server optimizer being configured to generate a SQL Server MEMO.

19. The system as recited in claim 18, wherein the control node being configured to parallelize the serial query plan search space into a parallel query plan search space comprises the e control node being configured to transform the SQL Server MEMO into a parallel MEMO.

20. The system as recited in claim 19, wherein the parallel-aware optimizer being configured to generate cost estimates for operations contained in the augmented data structure comprise the parallel-aware optimizer being configured to generate cost estimates for one or more of: replicate operation, a shuffle operation, a broadcast operation, a partition move operation, and a master move operation, contained in the parallel MEMO.
